(19) United States
(12) Patent Application Publication
(10) Pub. No.: US 2025/0190770 A1
(43) Pub. Date: Jun. 12, 2025

(54) METHOD FOR PROCESSING SUBSTRATE BY USING LASER AND SYSTEM THEREOF

(71) Applicant: National Cheng Kung University, Tainan (TW)

(72) Inventors: YU-LUNG LO, Tainan (TW); DILEEP KARNAM, Andhra Pradesh (IN); CHIA-HUA YANG, Tainan (TW)

(21) Appl. No.: 18/960,038

(22) Filed: Nov. 26, 2024

Related U.S. Application Data
(60) Provisional application No. 63/607,598, filed on Dec. 8, 2023.

(51) Int. Cl. G06N 3/0475; B23K 26/14; B23K 26/38; B23K 101/40

(52) U.S. Cl. CPC G06N 3/0475; B23K 26/14; B23K 26/38; B23K 2101/40

(57) ABSTRACT

The invention provides a method for processing a substrate by using laser, which includes: a substrate providing step, providing a substrate; a fluid applying step, applying a fluid on the substrate; and a laser applying step, applying a laser to the substrate under the fluid so as to perform a laser processing on the substrate, wherein the types of laser processing include drilling, cutting, grooving, trimming or trenching. At the same time, the present invention also discloses a system for processing a substrate by using laser. Through the selection of different fluid types, the present invention can achieve different laser processing effects so as to meet market demands.

### CROSS-REFERENCE TO RELATED APPLICATION

This application claims the benefit of provisional application Ser. No. 63/607,598, filed Dec. 8, 2023. The disclosure of the above application is incorporated herein in its entirety by reference.

### FIELD OF THE INVENTION

The present invention relates to laser drilling, especially a laser drilling method for producing TSV by using fluid assisting and artificial neural network simulating and a system thereof.

### BACKGROUND OF THE INVENTION

In the 3D package field, through silicon via (TSV) provides the interconnection inside the integrated circuit (IC), in other words, an electronical connection can be formed between IC. TSV is widely used for producing microelectromechanical systems (MEMS), mobile phone, memory chip, complementary metal-oxide-semiconductor (CMOS), and biosensor. TSV is produced by variable techniques comprising wet chemical etching, plasma dry etching, deep reactive ion etching (DRIE). However, limitations exist in the aforementioned techniques including, for example, anisotropic etching, low aspect ratio and multiple photolithography, and is not suitable for large-scale implementation.

Accordingly, a new TSV producing method is required for solving the problem mentioned above.

### SUMMERY OF THE INVENTION

To solve the problem, an aim of the present invention is to provide a method for processing substrate by using laser, comprising: a substrate providing step: providing a substrate; a fluid applying step: applying a fluid on the substrate; and a laser applying step: applying a laser through the fluid and performing a laser processing on the substrate so as to obtain a processed substrate, wherein the laser processing comprises laser drilling, laser cutting, laser grooving, laser trimming, laser trenching, or any combination thereof.

The method as mentioned above, wherein the fluid applying step further comprises: a fluid membrane forming step: forming a fluid membrane on the substrate, wherein the fluid membrane is formed by of the fluid adhering on the substrate, and at the laser applying step, the laser is applied to the substrate under the fluid membrane so as to perform the laser processing on the substrate.

The method as mentioned above, wherein the fluid comprises water mist, compressed air, or a fluid containing a carbon material.

The method as mentioned above, wherein the fluid comprises a carbon material containing nanofluid comprising carbon nanotube (CNT) nanofluid, graphite nanoplatelet nanofluid, graphene nanoplatelet nanofluid, fullerene nanofluid, carbon nanoribbon nanofluid, carbon nanowire nanofluid, carbon nano fiber nanofluid, or any combination thereof.

The method as mentioned above, further comprising: a parameter optimum value predicting step: predicting an optimum value of a parameter in the laser applying step by using an artificial neural network (ANN) model, wherein at the parameter predicting step, an optimum value of the laser processing under an atmospheric condition without applying the fluid is predicted, wherein the optimum value of the parameter corresponds to an optimum laser value of the laser.

The method as mentioned above, wherein the parameter optimum value predicting step comprises: a model establishing step: establishing a value design model containing a laser value, and the laser value comprises a pulse energy value of the laser and a pulse number value of the laser; a first simulating step: performing a first substrate processing simulation by using N of the laser values in the value design model, thereby obtaining a first simulating result, wherein the N is a positive integer; a first experimenting step: performing a first substrate processing experiment by using a part of the N of the laser values in the value design model, thereby obtaining a first experimenting result; a extracting step: extracting a first value of the parameter from the first simulating result and extracting a second value of the parameter from the first experimenting result; a simulating result validating step, comparing the first value of the parameter with the second value of the parameter so as to validate the simulating result; a model confirming step: confirming whether the value design model is reliable, and if not, returning to the simulating step for reassessing the value design model; an artificial neural network training step: following the model confirming step if the value design model is reliable, calculating the N of laser values in the value design model by using an artificial intelligence software, so as to train the artificial neural network (ANN) model; a processing map establishing step: establishing a processing map for the parameter by using the artificial neural network (ANN); a processing map overlaying step: overlaying the processing maps so as to establish a final processing map; and a processing map filtering step: filtering the final processing map so as to recognize an ideal region on the final processing map, wherein the ideal region comprises the optimum laser value.

The method as mentioned above, further comprising: a second simulating step: performing a second substrate processing simulation by using the optimum laser value, so as to generate a second simulating result; and a simulating result drawing step: analyzing and drawing the second simulating result.

The method as mentioned above, further comprising: a second experimenting step: performing a second substrate processing experiment by using the optimum laser value, so as to generate a second experimenting result; and a SEM analyzing step: analyzing a substrate structure of the second experimenting result by using a scanning electron microscope (SEM).

Another aim of the present invention is to provide a system for processing substrate by using laser, comprising: a substrate offering device, which is used for offering a substrate; a fluid applying device, which is electronically connected to the substrate offering device and is used for applying a fluid on the substrate; and a laser applying device, which is electronically connected to the fluid applying device and is used for applying a laser through the fluid and performing a laser processing comprising laser drilling, laser cutting, laser grooving, laser trimming, laser trenching, or any combination thereof.

The system as mentioned above, wherein the fluid comprises water mist, compressed air, or carbon material containing nanofluid, wherein the carbon material containing nanofluid comprises carbon nanotube (CNT) nanofluid, graphite nanoplatelet nanofluid, graphene nanoplatelet nanofluid, fullerene nanofluid, carbon nanoribbon nanofluid, carbon nanowire nanofluid, carbon nano fiber nanofluid, or any combination thereof.

The system as mentioned above, further comprising: an optimum value predicting device, which is electronically connected to the laser applying device, and is used for predicting an optimum value of a parameter by using an artificial neural network (ANN) model, wherein the prediction of the optimum value from the laser process is measured under an atmospheric condition without applying the fluid.

Accordingly, the present invention provides a method, combining an artificial neural network and a fluid-assisted drilling, for investigating the effect of a nanosecond laser drilling. After a cross-validation based on a simulation and an experiment, an optimum value, which can be obtained from the artificial neural network model that predicts a laser process under an atmospheric condition without applying the fluid, enhances performance of the nanosecond laser drilling when assisted by spraying fluid, in both an effective and a time-saving manners. In conclusion, the present invention provides a new TSV producing method, and solves traditional problems of laser drilling by using thereof.

### BRIEF DESCRIPTION OF THE DRAWINGS

FIG. 1A shows a laser processing system for laser drilling.

FIG. 1B is a schematic diagram showing the cross section of laser pulse drilling.

FIG. 2A is a region size schematic diagram of thermal simulating model.

FIG. 2B is a thermal distribution schematic diagram of thermal simulating model.

FIG. 2C is a TSV geometric structure schematic diagram of thermal simulating model.

FIG. 2D is a laser pulse output schematic diagram of thermal simulating model.

FIG. 3 is a flow diagram showing the preparation of the surrogate model for predicting data.

FIG. 4 is a flowchart showing the steps for coupling the artificial neural network and simulating model.

FIG. 5A shows a through hole result comprising experiment result and simulation result.

FIG. 5B shows a blind hole result comprising experiment result and simulation result.

FIG. 6A is a processing map with regard to the depth of ablation of TSV.

FIG. 6B is a processing map with regard to the aspect ratio of TSV.

FIG. 6C is a processing map with regard to the taper angle of TSV.

FIG. 6D is a processing map with regard to the thickness of heat affected zone.

FIG. 7 is a final processing map after filtration showing an ideal region (703).

FIG. 8 is a schematic diagram showing the cross section of TSVs, wherein the TSVs are produced according to the data point in the ideal region.

FIG. 9 is a SEM diagram showing the top surface of TSVs, wherein the TSVs are produced according to the data point in the ideal region.

FIG. 10 is a SEM diagram showing the cross section of TSV.

FIG. 11A is a bar graph illustrating the experiment result and simulation result of via entrance diameter.

FIG. 11B is a bar graph illustrating the experiment result and simulation result of via exit diameter.

FIG. 11C is a bar graph illustrating the experiment result and simulation result of ablation depth.

FIG. 12A is a schematic diagram showing the laser drilling performed by DLM.

FIG. 12B is a schematic diagram showing the laser drilling performed by ALM.

FIG. 12C is a schematic diagram showing the laser drilling performed by WLM.

FIG. 12D is a schematic diagram showing the laser drilling performed by CLM.

FIG. 13 is a final processing map after filtration as shown in FIG. 7, wherein the data point in the ideal region (1301) are re-selected.

FIG. 14A is an optical microscope image showing the cross section of TSV produced by DLM.

FIG. 14B is an optical microscope image showing the cross section of TSV produced by ALM.

FIG. 14C is an optical microscope image showing the cross section of TSV produced by WLM.

FIG. 14D is an optical microscope image showing the cross section of TSV produced by CLM.

FIG. 15A is a line graph for illustrating effect of laser values on the diameter of entrance, wherein the laser values are represented as the data point in ideal region in FIG. 13.

FIG. 15B is a line graph for illustrating effect of laser values on the diameter of exit, wherein the laser values are represented as the data point in ideal region in FIG. 13.

FIG. 15C is a line graph for illustrating effect of laser values on the recast layer, wherein the laser values are represented as the data point in ideal region in FIG. 13.

FIG. 15D is a line graph for illustrating effect of laser values on the taper angle, wherein the laser values are represented as the data point in ideal region in FIG. 13.

FIG. 15E is a line graph for illustrating effect of laser values on the thickness of HAZ, wherein the laser values are represented as the data point in ideal region in FIG. 13.

FIG. 15F is a line graph for illustrating effect of laser values on the aspect ratio, wherein the laser values are represented as the data point in ideal region in FIG. 13.

FIG. 16A-16D are SEM images of TSV entrance, wherein the TSV are produced in different environment.

FIG. 16E-16H are SEM images of TSV exit, wherein the TSV are produced in different environment.

FIG. 17A is a SEM image of cross section of data point C in DLM group.

FIG. 17B is a SEM image of cross section of data point C in ALM group.

FIG. 17C is a SEM image of cross section of data point C in WLM group.

FIG. 17D is a SEM image of cross section of data point C in CLM group.

FIG. 18 is a flowchart of method for producing TSV by using laser.

FIG. 19 is a flowchart of method for producing TSV by using laser.

### DETAILED DESCRIPTION OF THE INVENTION

The present invention aims to investigate the effects of a nanosecond laser drilling applying on a substrate comprising: silicon wafer, silicon carbide, gallium nitride, gallium arsenide, aluminum nitride, glass, third generation semiconductor, compound semiconductor, or molding compound. Compared to the traditional drilling method, the nanosecond laser drilling, having no photolithography step, which is comprised in traditional drilling method and is time-consuming, is a preferred method for rapidly, reliably, and environment friendly producing a through substrate via (TSV). In fact, for better quality of the TSV, several parameters of the TSV comprising roundness, diameter of the entrance and exit, taper angle, drilling depth, aspect ratio, heat affected zone (HAZ), and recrystallized layer are concerned, and an optimum value of each of the parameters are needed to be find. Further, in order to find the optimum value, multiple experiments for validating the relationship between the inputted parameter and the outputted result are required. Considering that performing multiple experiments are time-consuming and money-consuming, the present invention provides an effective and accurate method for solving this problem.

The provided laser drilling method of the present invention, different from traditional researches focusing on material removing mechanism, focuses on using machine learning and artificial intelligence during the laser drilling process to improve the production of TSV. The present invention develops a circle packing design (CPD) for generating a simulating result according to a laser value, wherein the laser value can be represented as a data point on a scatter chart, wherein a pulse energy is arranged on Y-axis of the scatter chart and a pulse number (No. of pulses) is arranged on X-axis of the scatter chart; further, the simulating result can be entered into the artificial neural network (ANN), thereby the artificial neural network (ANN) generates a predicted value corresponding to a parameter. After that, a filtration of an obtained processing map is performed according to four standard parameters comprising drilling depth, drilling taper angle, aspect ratio, and thickness of heat affected zone, so as to recognize an ideal region having proper depth, less taper angle, higher aspect ratio and heat affected zone with relatively lesser heat affection. And finally, comparing and experimenting a selected value of the parameters from the ideal region. The following is a detailed description elaborating the designation of the experimenting system.

The TSV experiment provided by the present inventing is performed by using a double-sided polishing n-type silicon wafer obtained from GREDMANN TAIWAN LTD®, wherein the diameter of used wafer is 6 inches, the thickness is 500±25 μm. The material properties of silicon are listed in Table 1. A nanosecond ytterbium fiber laser and a three-axis workstation are used for performing TSV experiment, wherein the wavelength of the nanosecond ytterbium fiber laser is 1064 nm, and the machine (YLPN-1000-4x200-30-M) used to generate the nanosecond ytterbium fiber laser is provided by IPG Photonics®.

The laser, a gaussian beam, exerted in a pulse repetition rate of a broadband range of 2-1000 kHz, thereby offers 1 mJ of a pulse energy, wherein the laser has a maximum power of 15 KW, an average power of 30 W, and a pulse waveform of 4-200 ns. The laser is focused on the top of the silicon wafer, wherein the focal length of the laser is 125 mm, the light spot of the laser is 30 μm in size, and the laser values used in the experiment are listed in Table 2.

TABLE 1
Temperature-related characters of silicon used in the
simulation of the prevent invention

| Character | Unit | Value |
|---|---|---|
| Density | Kg/m³ | 2.311 × 10³ − 2.63 × 10 ⁻²(T − Tₘ); Tₘ ≥ T |
| (ρ) | | 2.580 × 10³ − 0.17(T − Tₘ) − |
| | | 1.61 × 10⁻⁴(T − Tₘ)²; T > Tₘ |
| Thermal | W/m · K | 29900/(T-99) |
| conductivity | | |
| (k) | | |
| Specific heat capacity (Cₚ) | J/Kg · K | $( \frac{1 {0}^{6}}{ρ ( T )} ) = 1.4743 + \frac{0.17066 T}{300} ;$ |
| | | ${T}_{m} \geq T \frac{2.432 \times {10}^{6}}{ρ ( T )} ; T > {T}_{m}$ |
| Thermal | m²/s | 128/10⁴(T-159) |
| diffusivity | | |
| (α) | | |
| Latent heat of | J/kg | 1.79 × 10^{⁶} |
| fusion | | |
| (Lm) | | |
| Latent heat of | J/kg | 1.28 × 10^{⁶} |
| vaporization | | |
| (Lv) | | |
| Melting | K | 1687 |
| temperature | | |
| (Tm) | | |
| Vaporization | K | 3538 |
| temperature | | |
| (Tv) | | |
| Surface | N/m | 0.82 − 3 × 10⁻⁴(T − Tₘ) |
| tension | | |
| (γ) | | |

TABLE 2
Processing value of laser used in the present invention

| Parameter | Value |
|---|---|
| Average output power | 30 |
| (W) | |
| Repetition rate | 45 |
| (kHz) | |
| Pulse width | 100 |
| (ns) | |
| Laser beam quality | <1.5 |
| (M²) | |
| Wavelength | 1064 |
| (nm) | |
| Laser spot size | 30 |
| (μm) | |
| Wafer thickness | 500 |
| (μm) | |
| Number of pulses | 200-1000 |
| (No. of pulses) | |

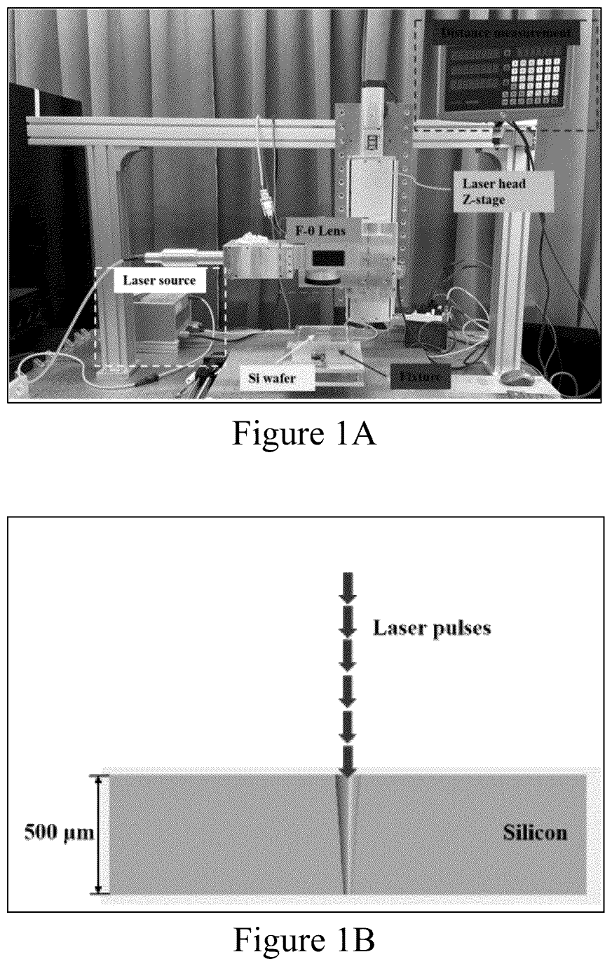

As shown in FIG. 1A, which is a schematic diagram of a laser processing system for the TSV production. After an adjustment, the nanosecond laser emitted by laser source is focused on the wafer surface through the F-theta lens. As shown in FIG. 1B, as provided by the present invention, a TSV is produced by using a laser-shock peening strategy. A work stage of the laser processing system is used for moving the wafer in directions of three-dimensional space; the wafer is arranged on a clamp; all the experiments are performed under room temperature and normal pressure. Before and after the laser process, the wafer is cleaned by ultrasonic vibration for 15 minutes with using acetone and ethanol as a first cleaning step, and with using water as a second cleaning step. Subsequently, precisely cutting the TSV in half by using a diamond wafer cutting machine for generated a cross section of the TSV, and then the TSV is undergone a grind. The cross section is analyzed by using an optical microscope (OLYMPUS® BX51M), and is further analyzed by using a field-emission scanning electron microscope (HITACHI® SU-5000) and an energy-dispersive X-ray spectroscopy (EDAX®) in detail.

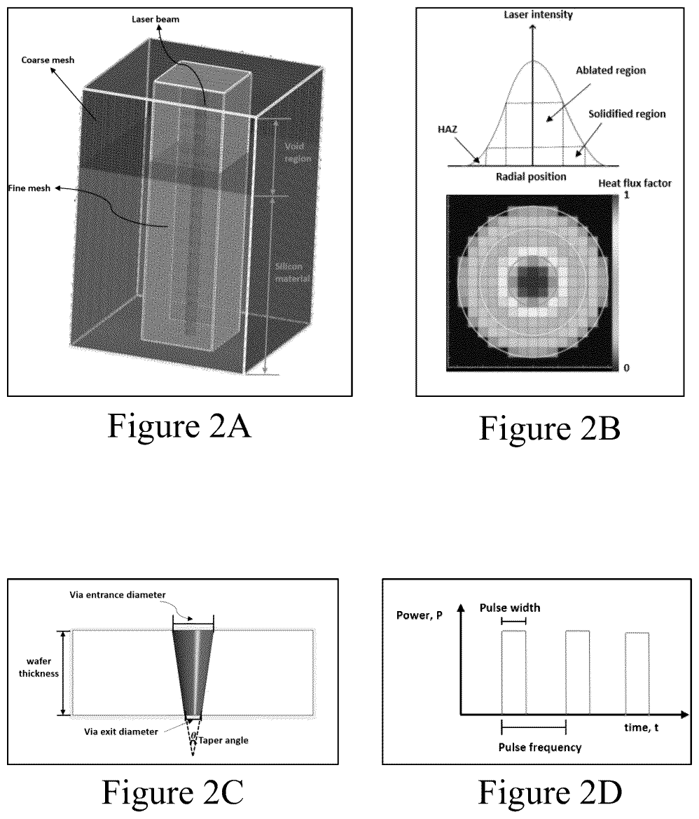

In the present invention, a commercial software Flow 3D® is used for simulating a laser-shock drilling on the silicon wafer. The model as shown in the FIG. 2, the size of region is 500 μm×500 μm, the z-axis represents the wafer thickness, which is an original value used in the experiment. As shown in FIG. 2A, based on the reason that a thin grid contributes to the accuracy of estimating result, a grid comprising a thick grid (sized in 7 μm) and the thin grid (sized in 6.5 μm) are used respectively for calculating values with reference to a laser spot's diameter. Vacant area is referred to as an air under the regular atmospheric condition, wherein the regular atmospheric condition comprising an initial temperature (293K) and an atmospheric pressure (1.013 bar). FIG. 2B illustrates a heat flux distribution from the core of the laser to the edge. Laser affecting zone comprising ablation zone, solidification zone, and heat affected zone. FIG. 2C describes the geometry of TSV. As described above, with regards to the TSV, a diameter of an entrance, a diameter of an exit, and a taper angle of a channel formed between the entrance and the exit are used for calculating an output value as described in the present invention respectively. As shown in FIG. 2D, a rectangular pulse profile is used, wherein parameter comprising pulse width, pulse frequency, and pulse energy are concerned.

First, a parameter optimization is established by using a surrogate model.

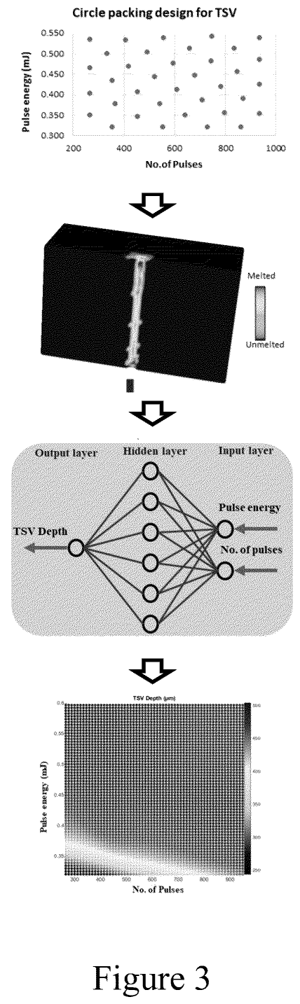

In the manufacturing field, designing the process using the surrogate model to replace traditional complex model, wherein the surrogate model has rapid calculation speed when the amount of calculation is small, is contributed to accelerate the optimization of the process. In the method provided by the present invention, a trained artificial neural network (ANN) model is used to find the optimized processing map by obtaining the pulse energy (E) on the Y-axis and obtaining the pulse number (N) on the X-axis. The 4 steps for establishing the surrogate model are shown in FIG. 3, first step, performing a simulation, wherein a circle packing design (CPD) is generated using 36 points within a given range, and the combination of any of the 36 points are used for the simulation; second step, performing a prediction for controlling the quality of TSV, wherein according to a standard parameter comprising depth of drilling, taper angle of drilling, aspect ratio of drilling and heat affected zone; third step, a data prediction chart having 3600 points of the standard parameter is generated by entering a simulating result into the trained artificial neural network (ANN) model; fourth step, generating a single parameter predicting map by overlapping multiple parameter predicting maps comprising those standard parameters, wherein the parameters are distributed to divided region.

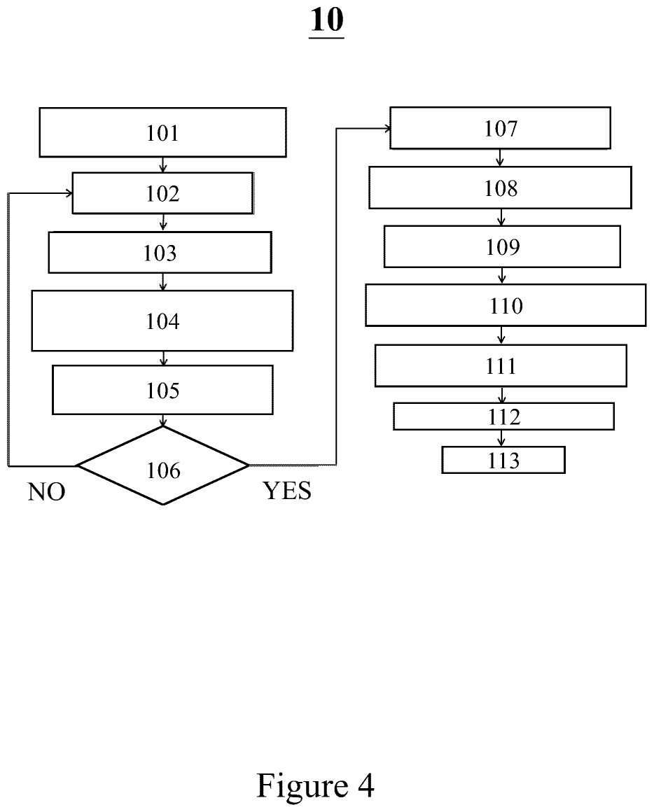

With reference to FIG. 4, which describes a method for predicting optimum parameter using artificial neural network 10 of the present invention, comprising: step 1, a model establishing step 101: establishing a value design model containing a laser value comprising a pulse energy value of the laser and a pulse number value of the laser, conceivably, the laser value can be referred to a data point having a (X, Y) value on a scatter chart, wherein the Y-axis of the scatter chart represents the pulse energy, the X-axis of the scatter chart represents the pulse number; moreover, the value design model can be circle packing design (CPD) model, and is not limited to this; step 2, a first simulating step 102, performing a TSV simulation by using N of the laser value in the circle packing design (CPD) model, so as to obtain_a simulating result, wherein the N is positive integer; for example, if the N is 36, then the TSV simulation is performed by using 36 of laser values in the value design model; step 3, a first experimenting step 103, experimenting part of N of the laser values in the circle packing design (CPD) model during the TSV simulation, thereby obtaining an experimenting result, for example, experimenting 20% of N of the laser values thereby obtaining the experimenting result for further validating the simulating result; step 4, a extracting step 104, extracting a value of the parameter from the simulating result and from the experimenting result respectively, concretely, the value of a first parameter is extracted from the simulating result, and the value of a second parameter is extracted from the experimenting result, wherein the first parameter comprises the diameter of the TSV, heat affected zone (HAZ), taper angle, ablation zone, aspect ratio, or any combination thereof, the second parameter comprises the diameter of the TSV, heat affected zone (HAZ), taper angle, ablation zone, aspect ratio, or any combination thereof; step 5, a simulating result validating step 105, validating the simulating result by means of the experimenting result, and comparing the first parameter with the second parameter at the same time; step 6, a model confirming step 106, confirming whether the value design model is available; if not, get back to the model simulating step 102 for reassessing the value design model; if yes, proceed to step 7; step 7, an artificial neural network training step 107, training an artificial neural network (ANN) model with the N of the laser value in the CPD model by using an artificial intelligence software for example MATLAB®, wherein the N is a positive integer, for example is 36; step 8, a processing map establishing step 108, establishing a processing map for the parameter by using the artificial neural network (ANN); step 9, a processing map overlaying step 109, overlaying the processing map comprising the parameter, so as to establish a final processing map; step 10, a processing map filtering step 110, filtering the final processing map, thereby an ideal region value can be recognized on the final processing map, wherein any one of the laser values in the ideal region of the final processing map corresponds to specific parameter comprising the diameter of the TSV, the heat affected zone (HAZ), taper angle, ablation zone, or aspect ratio; step 11, a final processing map simulating step 111, performing the TSV experiment according to value selected from the A-I point in the final processing map, thereby generating a final simulating result; step 12, a final processing map descripting step 112, analyzing and drawing the final simulating result of A-I point, and cross-validating the model; step 13, a SEM analyzing step 113, analyzing the structure of the TSV by using a scanning electron microscope (SEM).

Understandably, the final processing map simulating step 111 can be further divided into a final processing map simulating step and a final processing map experimenting step, wherein in the final processing map simulating step, a simulation of the TSV is performed by using the selected value from the final processing map, and in the final processing map experimenting step, an experiment of the TSV is performed by using the selected value from the final processing map. The final processing map descripting step 112, subsequent to the final processing map simulating step 111, is followed for analyzing and drawing the final simulating result of the selected value. The SEM analyzing step 113, subsequent to the final processing map descripting step 112, is followed for analyzing the structure of the TSV by using a scanning electron microscope (SEM).

In this embodiment, from the establishment of CPD to the experiment finished at the end, there are 36 laser values used for simulation. In the process of simulation, 20% of laser values are selected for the validation of the simulating results, and then the biggest error between one of the validated simulating results to the other is 5.09%, which indicates that the model provided by the present invention has been validated clearly. Next, training the ANN model by using the parameter derived from the simulation so as to establish the processing map in a given range, and integrating all the single parameter so as to establish a filtrated processing map. In the end, performing a simulation and an experiment using the selected point (A-I) in the final processing map so as to exam the model provided by the present invention, and analyzing the TSV structure through SEM in detail.

Second: validation of the calculating model.

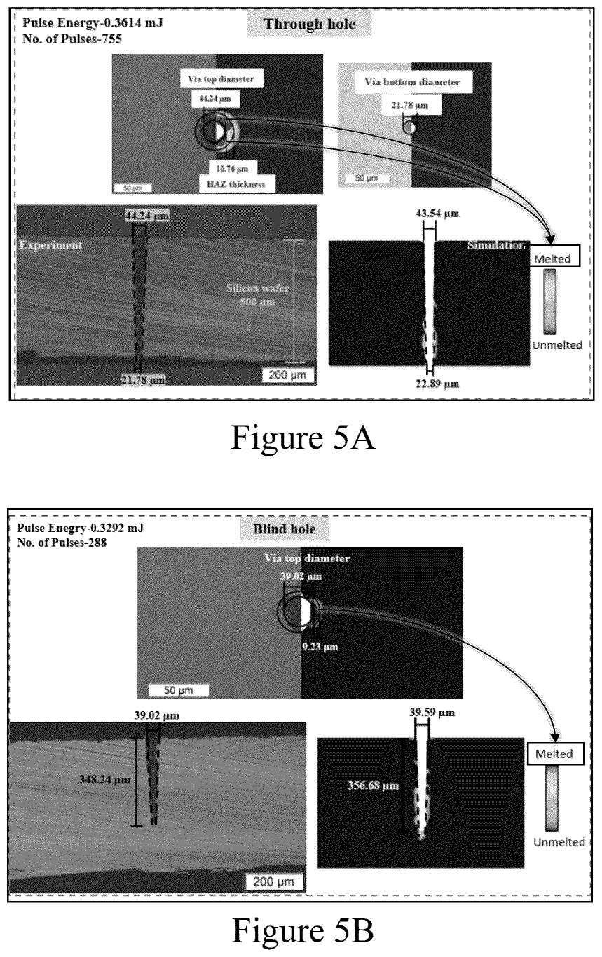

In order to validate the simulating result of the model provided by the present invention, a comparison result as shown in FIG. 5A and FIG. 5B demonstrates the TSV comprising blind hole and through hole of the experimenting result and the simulating result in the air. The laser condition can be found on the upper left corner of FIG. 5A and FIG. 5B. With regard to the through hole, FIG. 5A demonstrates that the diameter of top opening is 44.24 μm, the diameter of bottom opening is 21.78 μm respectively, and the thickness of the HAZ on the upper side of the wafer is 39.02 μm. With regard to the blind hole, FIG. 5B demonstrates that the diameter of top opening is 39.02 μm, and the thickness of the HAZ on the upper side of the wafer is 9.23 μm. The depth of the blind hole is 348.24 μm in the experiment, and is 356.68 μm in the simulation respectively. With respect to ablating crystalized silicon using nanosecond laser, the crystalized silicon starts to melt after receiving enough pulse energy, and the melted silicon further starts to evaporate after reaching its evaporation point. Subsequent, the remaining melted silicon starts to solidify due to insufficient latent heat. The diameter of the through hole top opening, the diameter of the through hole bottom opening, the taper angle, the ablation zone, the aspect ratio, or the heat affected zone (HAZ) are calculated according to the formula provided by the simulation and the experiment. As shown in FIG. 5A and FIG. 5B, the simulating model provided by the present invention can serve as a reliable tool for prediction in given range of parameter.

Third: determination of the ideal region in the processing map.

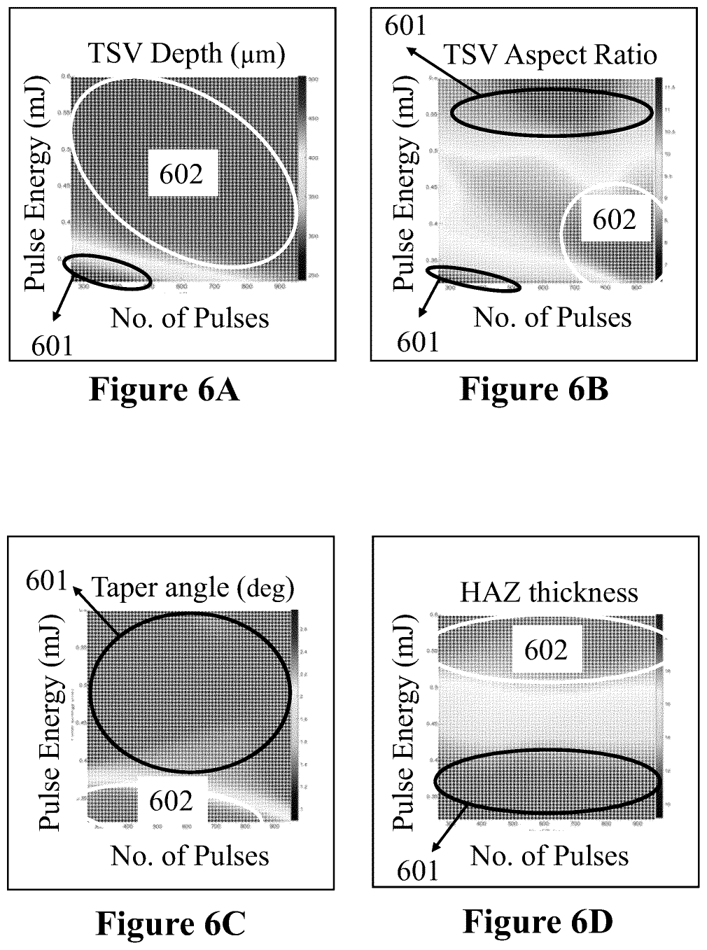

1. TSV processing map with depth standard: with respect to forming interconnecting unit using TSV, as a key factor, the ablation determines whether the TSV becomes a through hole or a blind hole. The depth of the through hole formed by using nanosecond laser with different pulse energy and pulse number is shown in FIG. 6A, in which demonstrates that the depth of the through hole increases proportionally with the increase of the pulse energy and the pulse number, obviously, the more pulse number applies, the more laser energy the silicon absorbs, therefore the depth of the through hole increases. Likewise, the more pulse energy (E) applies, the more effective radiation on the surface of silicon forms, therefore the depth of the through hole increases.

As represented as blue part 601, a blind hole (<500 μm), based on surface ablation, is formed when the pulse energy is lower than 0.4 mJ and the pulse number is lower than 850. As represented as red part 602, a through hole (>500 μm) is preferred in the present invention. Apparently, in order to form the hole deeper, high pulse energy and high pulse number are required so as to expel the silicon from the hole. Throughout the entire experiment process, the pulse width and the laser frequence should keep constant, as illustrated in Table 2.

2. TSV processing map with aspect ratio standard: a formula (1) is used for calculating the aspect ratio (AR) of the TSV, as shown below.

$$TSV Aspect ratio ( AR ) = [ \frac{Ablation depth ( h )}{diameter of TSV} ] \qquad Formula ( 1 )$$

To achieve a manufacture with high yield rate, the high AR-TSV is preferred for solving the problem comprising warping caused by heating, wherein the high AR-TSV is configured to connect subsequent layers in silicon substrate. Compared to other methods, the method using TSV is preferred for achieving compacted package. Manufacture of 3D integrated circuit comprises forming through hole, forming deposition of sidewall insulation layer, and filling metal. The affection of pulse energy and the pulse number on AR of the TSV is shown in FIG. 6B, wherein the high aspect ratio (AR) is 11.5, improved parameters are represented as red. Those high AR-TSV are obtained using laser value comprising lower than 0.45 mJ of the pulse energy, and 600-900 of pulse number. The diameter of TSV increases proportionally with the increase of the pulse energy, and that leads relatively smaller aspect ratio. In addition, a blind hole will be produced on silicon wafer when the pulse energy is smaller than 0.35 mJ and the pulse number is smaller than 700 because of the laser energy is insufficient to produce a through hole.

3. TSV processing map with taper angle standard: the taper angle is defined by estimating cross section of the hole as show in a formula (2):

$$Taper angle ( θ ) = {tan}^{- 1} [ \frac{{d}_{ent} - {d}_{exit}}{2 h} ] \qquad Formula ( 2 )$$

In the formula (2), the dent is the diameter of the entrance of the through hole, the dₑₓᵢₜ is the diameter of the exit of the through hole, the h indicates the height of TSV (500 μm). As shown in FIG. 6C, which illustrates the correspondence between the simulating result of TSV taper angle and the pulse energy and the pulse number, the taper angle decreases with the increase of the pulse energy and the pulse number. Due to the fact that taper angle is related with the diameter of the TSV, the effect of the pulse energy and the pulse number on the diameter of the TSV affects the taper angle. That is to say, with the increase in the pulse energy and the pulse number, the energy absorbed by silicon material increases, which further leads to the diameter of TSV becoming greater and the taper angle of the TSV become lesser. With the same pulse energy, the diameter of TSV increases when the pulse number increases until a certain number, the reason regarding the above is that the effective area may depend on the pulse energy. With the same pulse energy, when the effective area reaches the peak value, the effective area will be constant even the pulse number further increases. The maximum taper angle of the blind hole is about 2.6°, as shown as red in the FIG. 6C. The present invention considers the blue region in the FIG. 6C, which represents the taper angle is less than 1.6°.

4. TSV processing map with heat affected zone (HAZ) thickness: the silicon material properties, comprising physic, chemical, and mechanic, are affected by the heat effect generated during the interaction between the laser and the silicon material, in other words, the definition of HAZ is the zone that affected by heat and adjacent to the processing surface exposed to laser. In the experiment, thickness of HAZ can be represented as formula 3, wherein the thickness of HAZ is the average of 8 of distinct point separated by 45°, and the HAZ measured by SEM image is shown in FIG. 6D. To determine the thickness of HAZ under the recast layer, a laser drilling is performed by air jet, thereby identifying that the size of the HAZ is the same as the thickness of recast layer. The recast layer can be removed by laser drilling and subsequent air jet, so as to find the HAZ around the TSV. In the simulation, HAZ can be recognized by phase change temperature (800 K) and melting temperature (1687 K) of Si, in other words, in the present invention, HAZ is identified as the zone that has at least 800K of temperature in Si.

$$HAZ thickness = [ \frac{( HAZ diameter - Via entry diameter )}{2} ] \qquad Formula ( 3 )$$

In order to investigate the effect of pulse energy and pulse number on thickness of HAZ, an ANN model is used to depict points as shown in FIG. 6D. The HAZ can be observed during the high energy drilling due to the heat accumulation around the TSV. Understandably, due to the same pulse energy and the same effective area, the pulse number has limited effect on thickness of HAZ. HAZ standard will be filtrated according to the minimum value in the processing map, concretely the blue region (<13 μm). Entering the improved HAZ into the processing map.

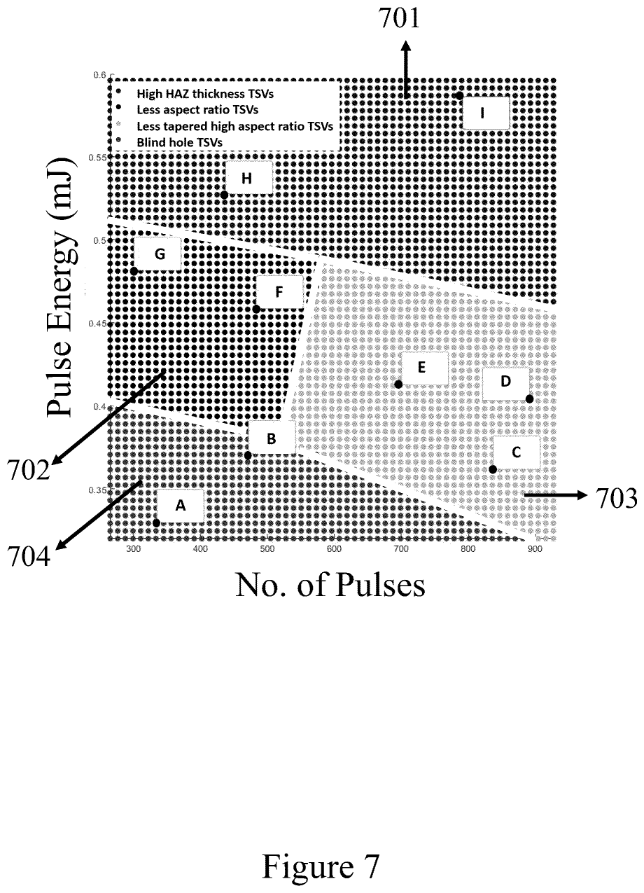

As shown in FIG. 7, which is a combination diagram generated by overlaying multiple processing map (for example FIG. 6) using MATLAB®. With regard to the location of any of data point representing laser value comprising pulse energy and the pulse number in the FIG. 7: the red part 704 represents TSV with blind hole; the black part 702 represents TSV with less aspect ratio; the blue part 701 represents the TSV with high HAZ thickness and is not preferred; and the green part 703 represents the TSV with less HAZ, high aspect ratio, and less taper angle, and is preferred. The any of data point are used in an experiment for validating the processing map, the result of the experiment will be further discussed in below. It is worth mentioning that, the software used for data analyzation and value calculation is not limited to the MATLAB, other software comprising artificial intelligence (AI), for example TensorFlow®, Theano®, Caffe®, Torch®, MXNet®, Pytorch®, or CNTK®, are able to be used for addressing the processing map including the standard parameter or value.

Fourth, the result of optical microscope (OM) and scanning electron microscope (SEM) for the TSV validation.

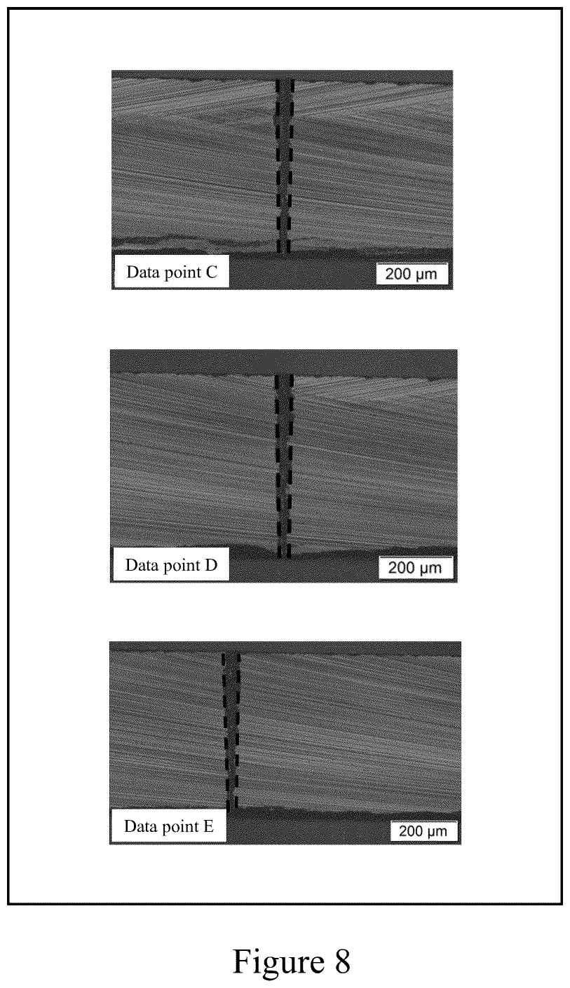

As shown in FIG. 8, the cross section of the TSV is observed by an OM, wherein the TSV are produced according to the data point locates in the ideal region (green part 703) shown in FIG. 7; the data point C corresponds to the laser value comprising 0.3614 mJ of pulse energy and 835 of pulse number, the data point D corresponds to the laser value comprising 0.4028 mJ of pulse energy and 892 of pulse number, the data point E corresponds to the laser value comprising 0.412 mJ of pulse energy and 698 of pulse number, respectively. Those results indicate that the TSV produced according to the data point located in the ideal region, has less HAZ, high aspect ratio, and less taper angle compare to the TSV produced according to the data point located in other region. In detail, the cross section of the TSV is processed using a diamond cutting machine, a crack observed on the cross section of the TSV of the data point C is produced by the diamond cutting machine.

Table 3 shows the parameters of the TSV in the final processing map, the parameter comprises the depth of ablation, the aspect ratio, the taper angle, and thickness of HAZ, wherein the TSV are produced according to the data points comprising A to I shown in FIG. 7. In comparison to different regions, a blind hole having lower AR and relatively larger taper angle is produced according to the data point A or B located in red part 704; a through hole having high aspect ratio (>11) and relatively less taper angle is produced according to the data point C, D, or E located in green part 703; a through hole having relatively smaller aspect ratio and more HAZ is produced according to the data point F or G located in black part 702 and is not preferred; a through hole having larger diameter, less aspect ratio, and more HAZ is produced according to the data point H or I located in blue part 701, wherein the more HAZ is triggered by high pulse energy.

TABLE 3
Experimenting result of data points represents
in the final processing map

| | | Depth of | | | Thickness |
|---|---|---|---|---|---|
| Data | Pulse energy/ | ablation | Aspect | Taper angle | of HAZ |
| point | Pulse number | (μm) | ratio | (degree) | (μm) |
| A | 0.3292/333 | 348.24 | 8.80 | 3.25 | 9.82 |
| B | 0.3706/470 | 447.87 | 10.66 | 2.68 | 10.37 |
| C | 0.3614/835 | 500 | 11.72 | 1.37 | 10.68 |
| D | 0.4028/892 | 500 | 11.30 | 1.32 | 10.76 |
| E | 0.4120/698 | 500 | 11.07 | 1.26 | 11.5 |
| F | 0.4258/481 | 500 | 10.52 | 1.23 | 14.29 |
| G | 0.4810/300 | 500 | 10.34 | 1.08 | 16.12 |
| H | 0.5270/436 | 500 | 10.15 | 1.02 | 18.94 |
| I | 0.5868/789 | 500 | 9.99 | 1.05 | 21.23 |

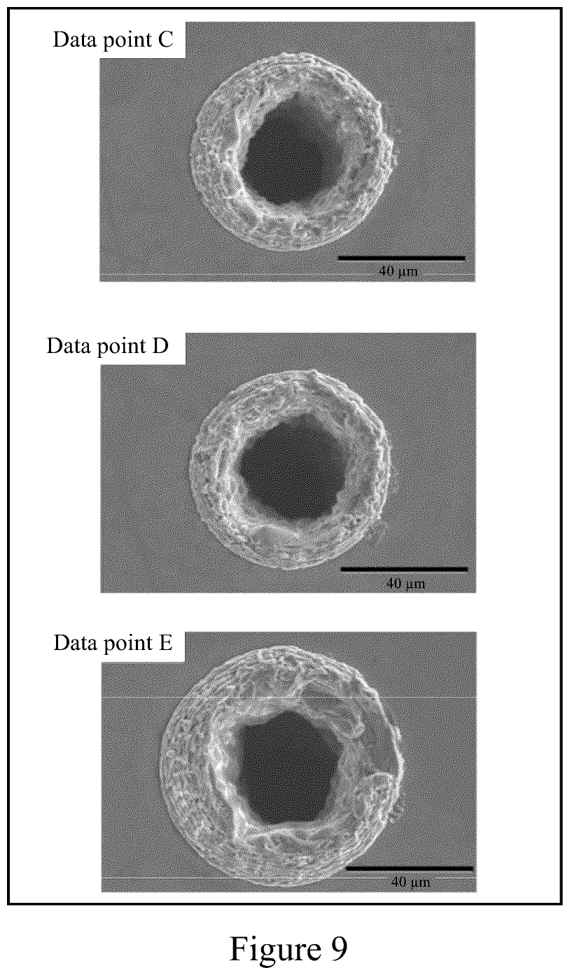

5. SEM analysis: in order to investigate the effect of recast layer, HAZ, or fused deposition on the laser drilling, observation on the top opening or on the cross section of TSV are performed by SEM. As shown in FIG. 9, which illustrates the via entry of TSV (entrance of through hole) in the ideal region (green part 703), wherein silicon material sprays out from the hole during the drilling and forms deposition around the hole. The size or the density of the sprayed-out silicon material depends on the pulse energy and the pulse number, wherein the silicon material deposition sprays more around the hole with the increase of the pulse energy and the same of the pulse number. It should be noticed that compare to the hole generated by less pulse number, the hole generated by more pulse number has more silicon material deposition around the hole. With regard to the HAZ, sprayed-out silicon material takes away most of the heat generated during the laser pulse. Due to the thermal diffusion, the sprayed-out silicon material contains a thermal residue. The thickness of HAZ is calculated according to Formula (3), as shown in FIG. 6D. As shown in FIG. 9, the thickness of HAZ increases with the increase of the pulse energy. Moreover, no matter the pulse energy and the pulse number are, the shape of opening of the TSV are approximately circular.

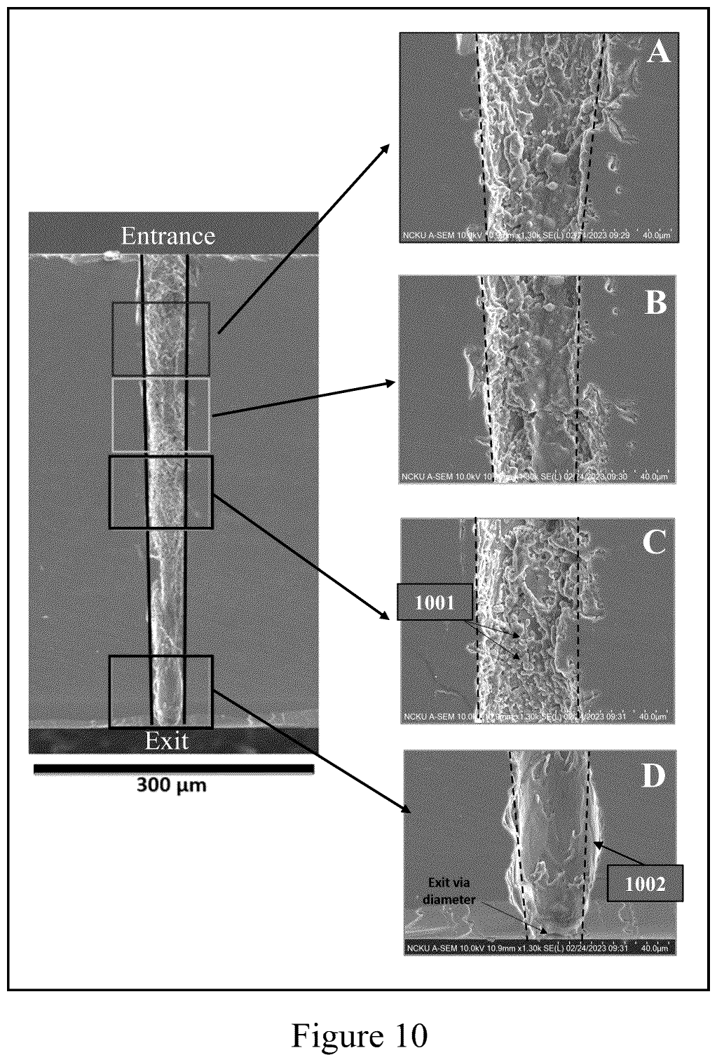

FIG. 10 illustrates the SEM diagram of cross section of TSV, wherein the TSV is produced by 0.412 mJ of pulse energy, and 698 of pulse number (data point E), wherein the entrance diameter of the via is 45.13 μm, the exit diameter of the via is 21.71 μm, the aspect ratio is 11.07, the taper angle is 1.260°, and the thickness of HAZ is 11.5 μm. As shown in frame A, with a possibility that atmospheric pressure may limit the melted silicon material spraying out from the hole, there are large silicon deposition found around the entrance of TSV. In addition, as shown in frame C, the resolidified silicon material 1001 blocks the middle part of the hole. A slightly bulge 1002 is formed in the bottom of the hole (exit of TSV), which may be caused by plasma shielding that triggered by deep drilling with high repetitive rate. The plasma is heated by the laser reflection on the inner wall of the hole, and has higher density compared to the flat surface. In fact, compared to other part of the inner wall of the hole, bottom part of the inner wall surface is smoother, on the other hand, except for the bottom part of the inner wall, other part of inner wall surface is rougher, and it is a common phenomenon for a laser pulse drilling in air environment.

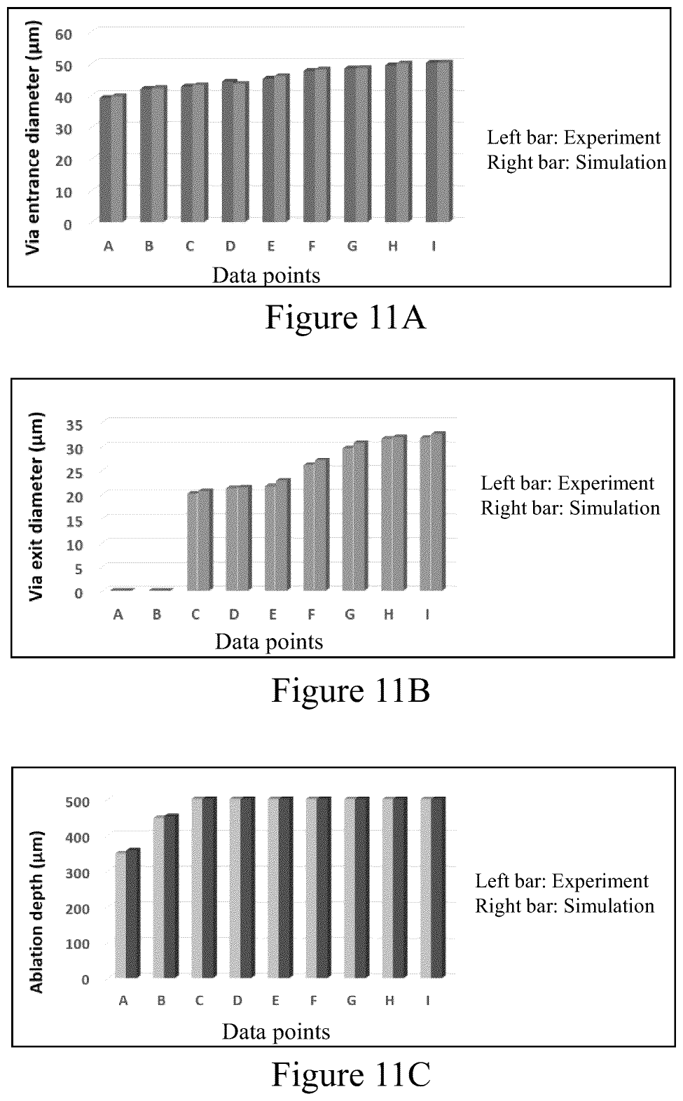

6. Comparison of the simulation and the experimenting: FIG. 11 illustrates the relationship between the simulation result and the experimenting condition. As shown in FIG. 11A, the via entrance diameter increases with the increase of the pulse energy, wherein the diameter ranges from approximately 39 to 50 μm, and data point I realized the largest diameter: 50.06 μm. As shown in FIG. 11B, data point A and data point B have no via exit diameter because they are blind hole. As shown in FIG. 11C, bias of the ablation depth of data point A between the simulation result and the experimenting result is 2.45%, bias of the ablation depth of data point B between the simulation result and the experimenting result is 1.04%. As mentioned above, other data point is through hole. The largest bias of the ablation depth between the simulation result and the experimenting result is 5.11% (data point E), which demonstrates that the good consistency.

One embodiment of the present invention provides TSV characterized in high aspect ratio, less taper angle, and less thickness of HAZ with using the nanosecond laser drilling and assistive surrogate model. To investigate the effect of pulse energy and pulse number on the formation of TSV, Flow-3D® is used for the simulation. Developed ANN model is contributed to find the ideal region in the processing map through combining the pulse energy and the pulse number. Subsequently, experimenting the laser value in any of the selected region so as to compare the experiment result and the simulation result. The followings are inferences based on those results.

The simulating result of TSV's shape comprising the via entry diameter, via exit diameter, and ablation depth, generated by the simulation model provided by the present invention, is proven to be comparable with the experimenting result of the same.

A function of ANN is successfully provided by the present invention, which can be used to predict such as ablation depth, aspect ratio, and thickness of HAZ, and is accurate when applied in a given range. An ideal region, composed of laser value comprising 0.35-0.45 mJ of pulse energy and 600-900 of pulse number, is filtrated in the final processing map, wherein the laser value can be used to produce TSV properly.

With the use of the optimum laser value (0.3614 mJ of pulse energy, 835 of pulse number) provided by the present invention, a TSV having high aspect ratio (11.72), small taper angle) (1.370°, and relatively less HAZ (10.48 μm) is formed on a silicon wafer (500 μm of thickness). When the pulse energy level is higher, due to the accumulation of heat, TSV having larger diameter, less aspect ratio, and more HAZ will be produced.

So far, although the predict model provided by the present invention is proven to be useful for predicting a optimum laser value of TSV, but most part of TSV inner wall′ surface is still rough. For the purpose of overcoming this problem, the following are laser drilling conducted in different environment.

TSV, produced on a thin silicon wafer, configured to vertically connect multiple stacked structures of the IC, is used in 3D package of semiconductor field. As a type of non-contact dry etching, laser drilling is a prospective technology for producing TSV. The following are laser drilling conducted in environments comprising air, compressed air jet, water mist, and carbon nanotube (CNT) fluid mist, so as to evaluate the effects of environment on the laser drilling. The optimum laser value (laser pulse energy and pulse number) mentioned above is obtained without applying any of fluid in the environment during the laser drilling, wherein the parameter of TSV is selected from the group consisting of drilling depth, taper angle, aspect ratio, thickness of HAZ, and any combination thereof, such the method for producing the TSV is effective, low-cost, and efficient. Compared with the different environments in which the laser drilling is conducted, TSV produced by laser drilling in CNT fluid mist is more like a cylinder, wherein the cylinder has clean inner wall. Compared to the air and the air jet, TSV has the minimal damage and has the minimal deposition of ablation fragments under the environment of water mist and CNT fluid mist. As a result, TSV produced by CNT fluid mist process (laser drilling in CNT fluid mist) has less recast layer (˜7 μm), less taper angle) (˜1.05°, and less thickness of HAZ (˜50 μm). It is known that, increasing the heat conductivity and flow rate of compressed water mist contributes to cooling and reducing the generation of ablation fragments during the drilling, thereby improving the processing quality. In addition, SEM observation is performed to explore the TSV.

In post-Moore's low era, the 3D package is characterized in TSV, wherein the TSV provides the shortest heat connecting route between the stacked structure in the chip so as to reduce the overall size. The quality of TSV plays a critical role in producing a device containing IC in the semiconductor industry, wherein the function and the accuracy of the device is affected by the TSV. Served as a non-photomask-used method and a single step process for producing the TSV, compared with traditional etching process, laser drilling presents better processing quality and aspect ratio. In general, pulse laser drilling comprises ultra-short pulse laser drilling and short pulse laser drilling, wherein a femtosecond (10⁻¹⁵) pulse laser and a picosecond (10⁻¹²) pulse laser are used in the ultra-short pulse laser drilling, and a nanosecond (10⁻⁹) pulse laser and millisecond (10⁻³) pulse laser are used in the short pulse laser drilling. Despite the ultra-short laser drilling has advantage of providing higher ablation efficiency and lesser HAZ on producing TSV, the short pulse laser drilling is more popular due to the cost of ultra-short pulse is higher than the short laser drilling. Somehow, if heat damage caused by the ultra-short laser drilling can be reduced, the cost can be reduced to achieve the purpose of cost savings. It is hard to, but should minimize the formation of fragment generated during the laser ablation process, so as to increase the surface smoothness, in other words, removing the fragments during ablation process for the purpose of preventing the fragment from subsequently attaching to the surface of the material, is beneficial to perform further processing on the material by using the laser.

Accordingly, fluid-assisted laser processing is a prospective technology for development, due to its ability in removing materials, reducing plasma formation, and removing fragments thereby obtaining clean surface on TSV.

One of the purposes of the present invention is aimed to find the idealist fluid used in the fluid-assisted laser drilling for producing TSV, therefore, a nozzle containing device is established for atomized a fluid during a first laser drilling, wherein the fluid comprises CNT nanofluid. The optimum laser values as mentioned above are used in the following TSV experiment, wherein the TSV experiment are conducted under different environments comprising dry laser machining (DLM), compressed air jet laser machining (ALM), water-mist assisted laser machining (WLM), or CNT-nanofluid mist assisted laser machining (CLM) respectively. As a result, TSV produced using CLM ablation process has better inner wall quality, less formation of recast layer, straighter via compared to TSV produced under other environment. The following elaborates the effect of the optimum laser values and the environment condition in the laser drilling on the diameter of TSV, aspect ratio, recast layer, thickness of HAZ, and taper angle.

The following relates to the experimental system.

First, setting up the laser device.

The present invention uses Yb-doped optical fiber system (YLPN-1000-4x200-30-M, IPG Photonics®) that exerts laser in 1064 nm of the wavelength, wherein the Yb-doped optical fiber provides 30W of average power with the 45 kHz of pulse repetition rate and 100 ns of pulse width. A F-theta lens is used for guiding and focusing the exerted laser to form light spot with 30 μm diameter on the top surface of the silicon wafer. FIG. 1 describes the laser processing equipment used to produced TSV. A double-sided polishing n-type silicon wafer obtained from GREDMANN TAIWAN LTD® is used in the present invention, wherein the thickness of the wafer is 500±25 μm.

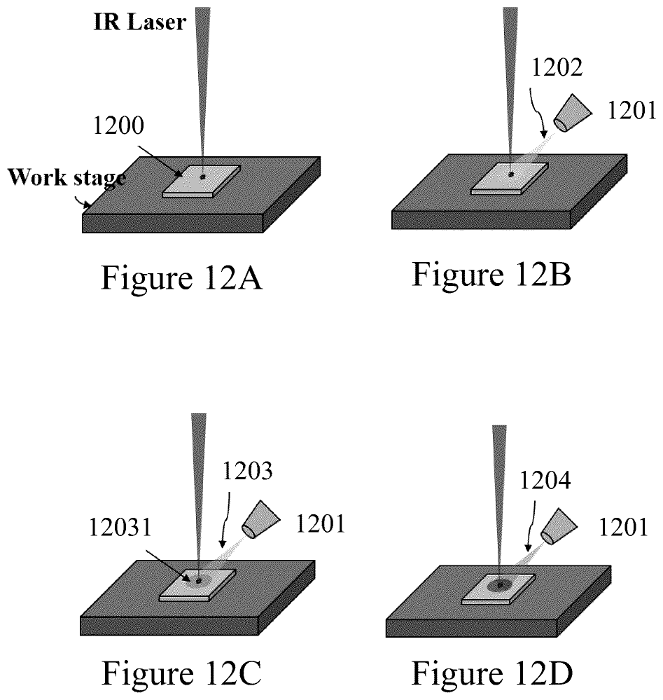

FIG. 12A to FIG. 12D illustrate four environments tested in the experiments of the present invention, comprising air (DLM), compressed air jet (ALM), water-mist (WLM), and CNT-nanofluid (CLM). With regards to those environments: DLM: all the steps are performed under normal atmosphere condition, as shown in FIG. 12A; ALM: laser drilling is performed on the processing region of the substrate 1200 with the use of compressed air 1202, as shown in FIG. 12B; WLM: using a nozzle 1201 to form a water mist 1203 by mixing the air and the water, and spraying the water mist 1203 so as to form a thin water membrane 12031 on the processing region of the substrate 1200, as shown in FIG. 12C; CNT: preparing CNT-nanofluid 1204, and spraying the CNT-nanofluid 1204 with the compressed air 1202 on the processing region, as shown in FIG. 12D. Those experiments use deionized water. A mist spraying system comprises: air source, hose, regulating valve, and nozzle 1201 (steel). The nozzle 1201 is arranged on a laser work stage of a substrate offering device, and is movable along with the laser work stage. The inclination angle of the nozzle's tip relative to the wafer surface is settled as 45°, the distance between the nozzle's tip and the wafer surface is settled as 20 mm. Before and after the laser processing, a cleaning step is conducted to clean the wafer by means of the acetone and ethanol, and a washing step is conducted to remove the acetone and ethanol after the cleaning step.

TABLE 5
Processing environment conditions as used in the present invention

| Environments | Descriptions |
|---|---|
| DLM | Atmospheric air only |
| ALM | Pressurized air jet |
| | (Air pressure: 2 bar) |
| WLM | Water + compressed air |
| | (Mist flow rate: 40 mL/s) |
| CLM | CNT + Water + compressed air |
| | (Mist flow rate: 40 mL/s) |

Second, preparing a nanofluid.

nanofluid, a colloidal suspension comprising a base fluid in which nano-particles are suspended, can be used to improve thermal conductivity due to its unique thermal properties and is therefore being applied widely in the field of thermal management. High aspect ratio and high thermal conductivity are the main reason for choosing the CNT-nanofluid in the present invention. The volume percentage for preparing the CNT-nanofluid is calculated according the following formula:

$$Vol \% = [ \frac{{( m / ρ )}_{CNT}}{{( m / ρ )}_{CNT} + {( m / ρ )}_{water}} ] \times 100$$

In the formula, “m” represents mass, “p” represents density. Multiwalled carbon nanotube (MWCNT) (obtained from Conjutek® Co., Ltd) is suspended in deionized water to reach 1 vol % with the use of ultrasonic generator. Due to the fact that the thermal conductivity of the-nanofluid will increase with the increase of CNT, the volume fraction of CNT in deionized water is not limited to 1 vol %, in some embodiments, the volume fraction of CNT in deionized water ranges from 0.5-3.0 vol %. The thermal conductivity of different mediums used in the present invention are shown in Table 7. It could be noticed that thermal conductivity of the CNT-nanofluid (˜0.6695 W·m⁻¹·K⁻¹) is higher than the thermal conductivity of the water (˜0.6155 W·m⁻¹·K⁻¹). The present invention performs laser drilling in four environments, the volume fraction of CNT in the CNT-nanofluid can be adjusted in order to increase the thermal conductivity.

TABLE 6
Properties of MWCNT

| Property | Value |
|---|---|
| Outer diameter (nm) | 10-20 |
| Inner diameter (nm) | 5-10 |
| Length (μm) | 10-30 |
| Aspect ratio | 1000-1500 |
| Specific surface area (m²/g) | >150 |
| Thermal conductivity (W · m⁻¹ · K⁻¹) | ~2000 |
| Density of pure substance | 2.1 |
| Purity | >95% |

TABLE 7
Thermal conductivity of mediums

| Type | Thermal conductivity (W · m⁻¹ · K⁻¹) |
|---|---|
| Air | 0.025 |
| Water | 0.6155 |
| CNT nano-liquid | 0.6695 |
| | (1 vol % of CNT) |

Third, Predicting the optimum laser value in the DLM.

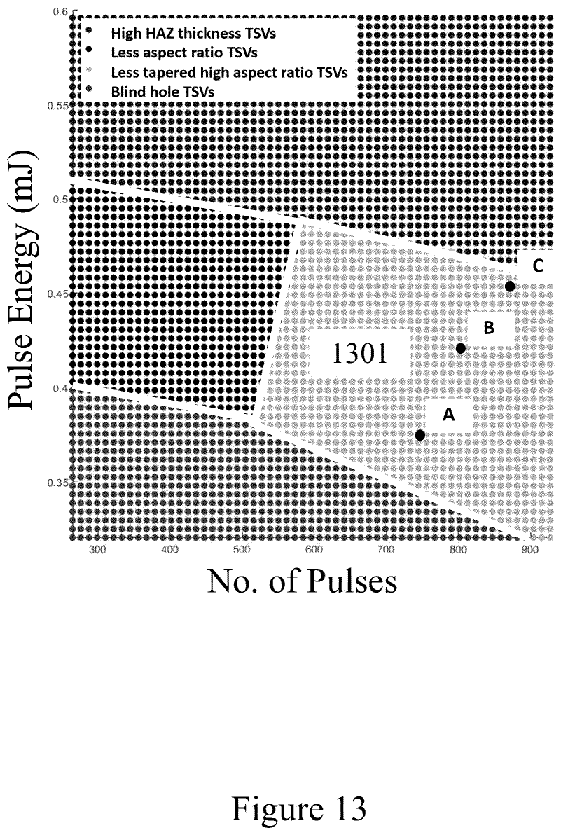

In order to exam the laser drilling of TSV production, a 3D simulating model is developed to export a simulating result using Flow-3D®, and the simulating result will be validated later. The simulating model is well-validated and can serve as a reliable tool for predicting values in a given range. The simulating data is input into trained ANN model for obtaining standard processing maps. FIG. 13 illustrates the filtrated processing map used in described embodiments of the present invention. In addition, first, in the DLM group, TSV production laser drilling is conducted by using artificial neural network (ANN) model in which random data points from regions are incorporated; secondly, an optimum laser value can be used to produce a TSV having higher aspect ratio, less taper angle, and relatively less thickness of HAZ. The optimum laser value of DLM is available from the ideal region 1301 as shown in FIG. 13 and can be applied in ALM, WLM, and CLM, so as to maintain the consistency of the whole experiment and enhance the reliability of the experiment.

The following comprises the result and discussion of the experiment.

In the first aspect, the result of optical microscope is discussed.

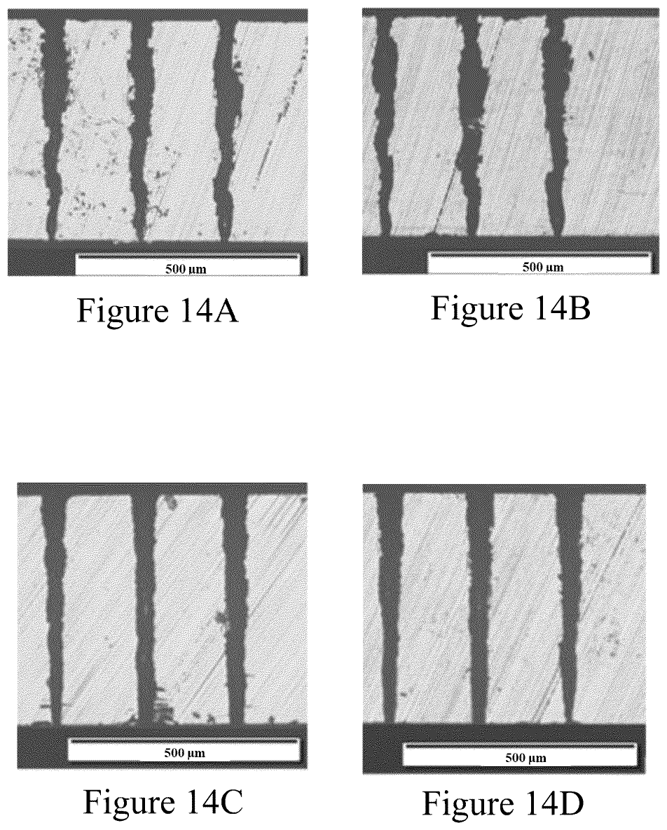

As shown in FIG. 14, which demonstrates the cross section of TSV, wherein different pulse energy and different pulse number are used in the laser drilling for producing the TSV. The results show that, in the DLM group, fragments are accumulated around the holes, and the holes have a curve shape; in the ALM group, some fragment clusters are removed from the holes, but the holes still have the curve shape; in the WLM group, most of the fragments are removed from the holes, which demonstrates that the WLM process is superior, but the holes have a taper shape; in the CLM group, compared to other group, the quality of hole's inner wall is improved, and the shape of the holes are linear.

In the second aspect, the following are the effects of pulse energy and pulse number on the shape of TSV.

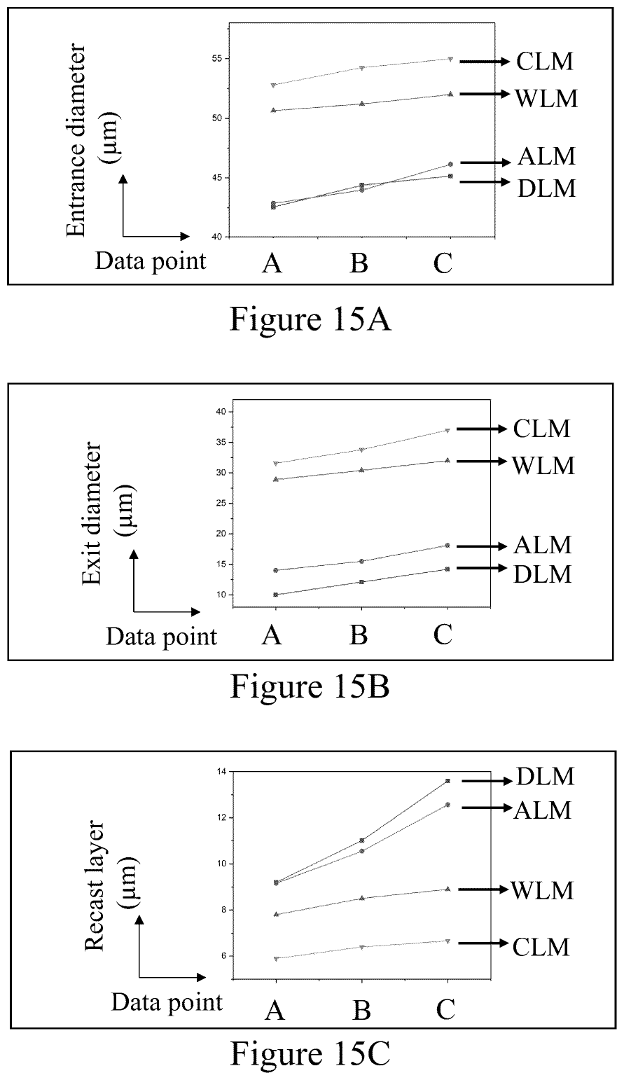

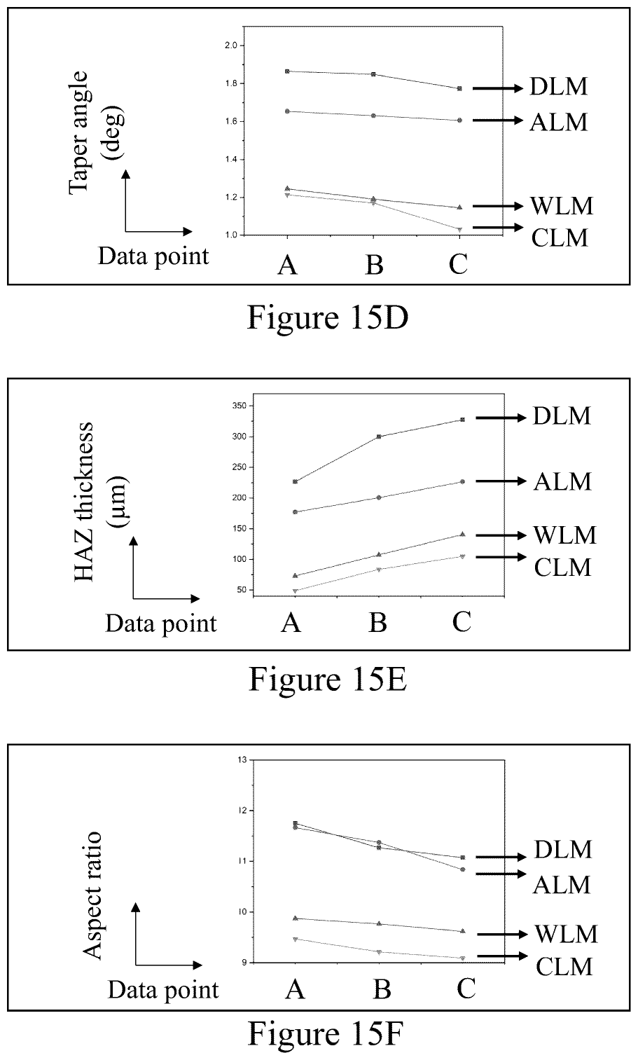

As shown in FIG. 15A to FIG. 15F, the effects of laser pulse energy and pulse number on the entrance of TSV, exit of TSV, recast layer, and taper angle, wherein the data points (comprising pulse energy and pulse number) is randomly chosen from the ideal region 1301 as shown in FIG. 13, the value of the data points are listed in Table 8.

TABLE 8
The value of the data points in the
ideal region 1301 as shown in FIG. 13

| | Pulse energy | |
|---|---|---|
| Data point | (mJ) | Pulse number |
| A | 0.38 | 751 |
| B | 0.42 | 806 |
| C | 0.46 | 862 |

### (1) TSV Diameter

As shown in FIG. 15A and FIG. 15B, the diameter of the entrance and the exit of the TSV increases with the increase of the laser pulse energy and pulse number. As mentioned above, the data point selected from the ideal region 1301 should be usable for generating the best TSV. In the DLM and ALM group, the entrance diameter of the TSV is similar to each other, and in the CLM group, the entrance diameter of the TSV is largest, as well as the exit diameter of the TSV, and that shows high ablation rate. In the WLM and CLM, the fragments in the processing region will be removed faster by means of flowing liquid.

### (2) Recast Layer

FIG. 15C shows that the width of recast layer varies with the change of the pulse energy and the pulse number, wherein the recast layer can be defined as the fragments accumulated around the hole due to the heat ablation. With the decrease of pulse energy, the size of the recast layer becomes smaller linearly. In the DLM process, the size of recast layer is approximately 14 μm due to the fragments cannot be removed by the air, further, in the ALM process, although the fragments inside the hole can be removed by the compressed air, the recast layer still cannot be removed by the compressed air. On the other hand, regarding the WLM and CLM process, the recast layer can be removed by the flowing liquid, thereby decreasing the recast layer.

### (3) Taper Angle

As shown in FIG. 15D, the experiment results demonstrate that the taper angle of TSV using the fluid assisted laser drilling is smaller. The taper angle can be defined as the following formula:

$$Taper angle ( θ ) = {tan}^{- 1} [ \frac{{d}_{ent} - {d}_{exit}}{2 h} ]$$

In the formula, the “dent” represents the entrance of the TSV, “dₑₓᵢₜ” represents the exit of the TSV, and “h” represents the thickness of the wafer. As the pulse energy increases, the entrance and the exit of the TSB increases, leading to a decrease in taper angle. Dur to the reason that the taper angle should be minimized for obtaining high quality of TSV, one of preferred embodiment of the present invention uses the CLM process to produce the TSV, wherein in the CLM process, fragments are washed away by the nanofluid, the laser pulse can hit the same point on the surface of wafer, thereby allowing the entrance and the exit of the TSV to become greater.

### (4) Thickness of HAZ

The thickness of HAZ can be defined as the horizontal distance between the entrance diameter and the HAZ diameter. As shown in FIG. 15E, as the pulse energy increases, the thickness of HAZ shows an increasing trend. Compared with air, water process and CNT-nanofluids process provides better cooling effect thereby reducing the thickness of HAZ. The results indicate that, compared to the drilling using the laser value having higher pulse energy and lower pulse number, the drilling the laser value having lower pulse energy and higher pulse number generates less HAZ, in other words, excessive energy level negatively impacts the HAZ and leads to the increase of HAZ. In CLM group, the smallest thickness of HAZ is 50 μm.

### (5) Aspect Ratio

The aspect ratio of TSV can be defined as the ratio between the wafer thick and the entrance diameter. As shown in FIG. 15F, due to the aspect ratio depend on the entrance diameter and the ablation rate is smaller, TSV shows high aspect ratio in DLM group, as well as in ALM. On the other hand, in the WLM and CLM group, high ablation rate results in larger entrance diameter, thereby generates TSV having relatively low aspect ratio. With regard to the aspect ratio, aspect ratio from high to low can be represented as
DLM>ALM>WLM>CLM.

In the third aspect, the following describes the result of SEM.

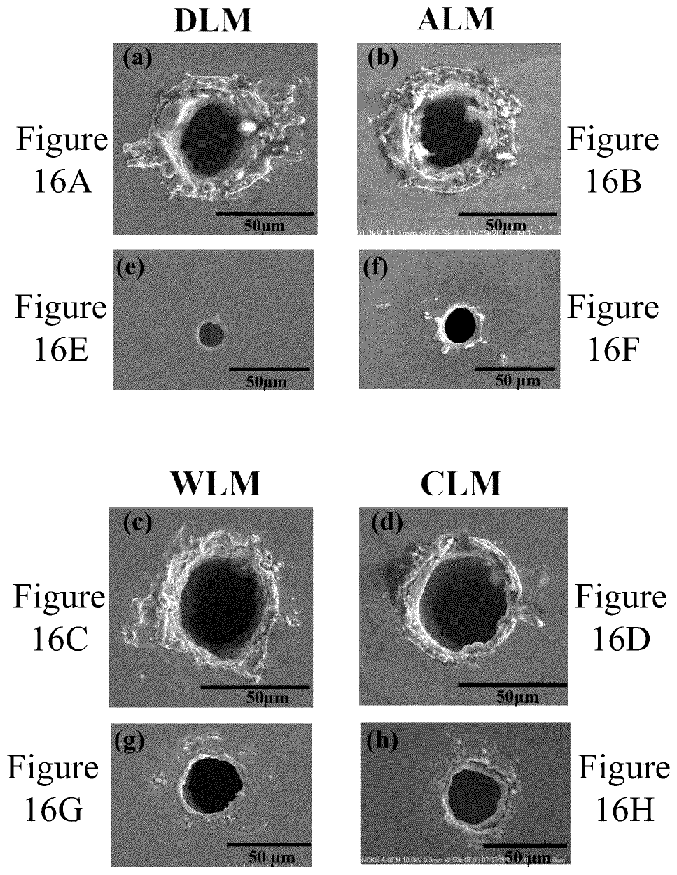

As shown in FIG. 16A to FIG. 16H, which illustrate the effect of different environments of TSV production on the entrance diameter and exit diameter of TSV, wherein the laser value used in the TSV production is selected as data point C as shown in Table 8 (0.46 mJ of pulse energy and 862 of pulse number). Under a constant pulse repetitive rate, the number and the density of fragments varies as the pulse energy and the pulse number increases. In DLM group, large and dense deposition can be observed around the entrance of the hole, which blocks the pulse energy to reach the bottom of the hole, and leads to the small exit diameter, as shown in FIG. 16E. Compared with DLM group, the entrance diameter of TSV generated from ALM group is similar to the entrance diameter of TSV generated from DLM group, the exit diameter of TSV generated from ALM group is larger than the exit diameter of TSV generated from DLM group, the compressed air removes the fragments from the hole, although the compressed air cannot remove the fragment on the surface of wafer, it will be discussed later. As shown in FIG. 16C and FIG. 16G, in WLN group, TSV having larger entrance and exit diameter and less surface fragments are observed. Different from in the air, in WLM group, solidified deposition around the hole edge of TSV can be removed by thin flowing water membrane; further, in CLM group, due to CNT-nanofluid suppress the formation of thermal gradient thereby preventing from thermal damage, TSV produced by CLM process has less fragments deposition around the hole. CNT-nanofluid has greater thermal conductivity than water, it should be one of the reasons explaining the less fragments. Detailly, great thermal conductivity may result from the less thermal boundary layer, rearrange of nanoparticles, and increase of shear-coupled thermal conductivity. Due to the increase in the amount of material removal, circular and larger TSV can be observed, as shown in FIG. 16D and FIG. 16H. Overall, due to the different refractive index associated with each medium, diameter of TSV produced in DLM and ALM group are smaller than the diameter of TSV produced in WLM and CLM group.

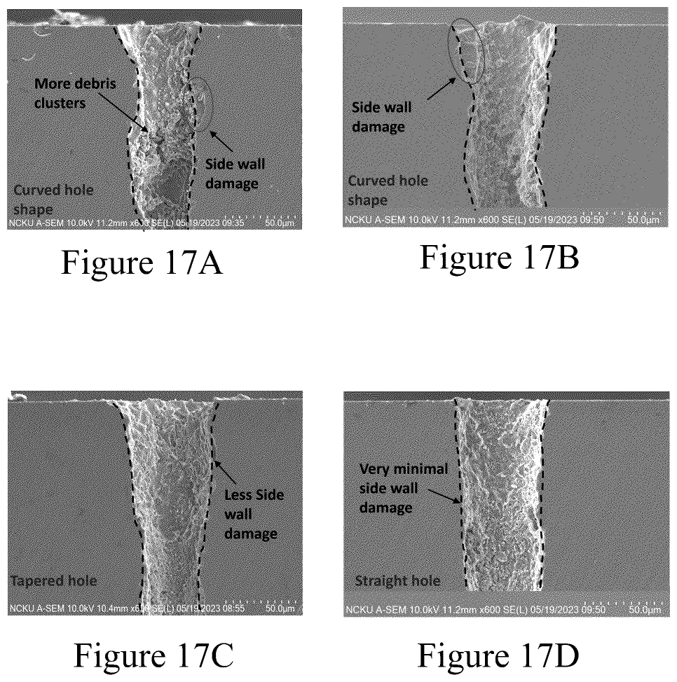

FIG. 17A to FIG. 17D are the SEM diagrams illustrating the top of cross section of TSV. It can be found that the TSV produced in DLM group have fragment clusters and inner wall damages. As shown in FIG. 17A, the fragment clusters block the laser to remove the materials from inner wall, and causes the TSV to become curved. As shown in FIG. 17B, the fragment clusters are removed by the compressed air, but damage of the inner wall remain, the shape of TSV is still curved. As shown in FIG. 17C, quality of TSV produced by WLM process is improved, wherein the water used in the WLM can reduce the surface temperature due to its high thermal conductivity compared to air, thereby causing the fragments to solidify rapidly, therefore damage of inner wall and the fragment deposition reduces in WLM process. Subsequently, the solidified fragment will be taking away from the processing region by the flowing water. As shown in FIG. 17D, in CLM group, TSV is linear and has very few inner wall damages. The predicted thermal conductivity demonstrates that, with the use of CNT-nanofluid, CLM group prevents the fragments from blocking the TSV thereby causing higher ablation rate, and that makes CLM process better than other processes.

The laser drilling conducted under the water contributes to the processing but does not contribute to remove the fragments from the processing region. Compared to dry processing, submerged processing needs more laser pulse energy for processing the same material. In order to solve this problem, a new method relates to an application of flowing liquid membrane is provided, wherein the method can be applied on substrate comprising silicon carbide and silicon and have the advantage comprising high ablation rate in the process, straight hole of TSV, less production of fragments, and clean surface of TSV. It is noticed that, thin water membrane is a fluid membrane formed by sending water to a position a few millimeters away from the laser light spot.

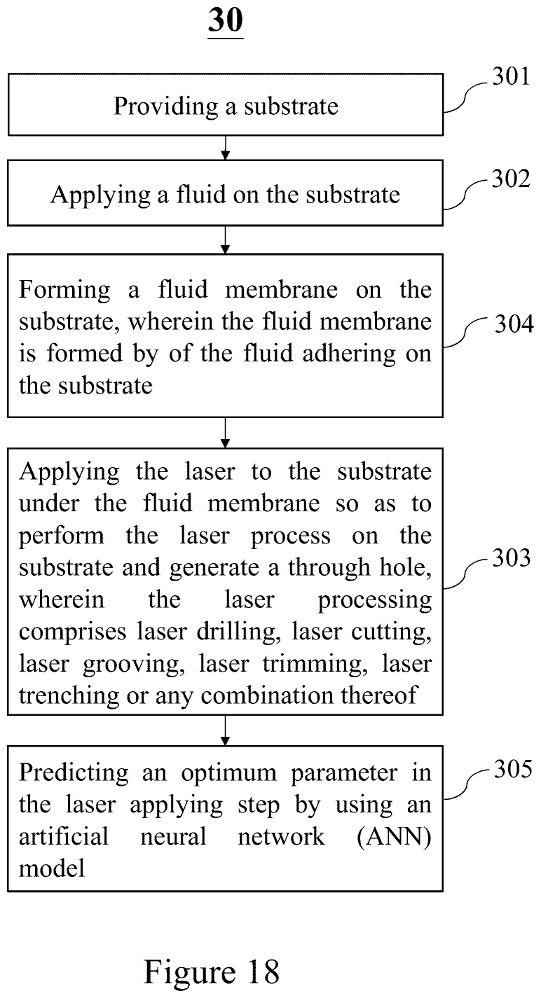

With reference to FIG. 18, the present invention provides a method for processing substrate by using laser 30, comprising: a substrate providing step 301, providing a substrate; a fluid applying step 302, applying a fluid on the substrate; and a laser applying step 303, applying a laser to the substrate under the fluid so as to perform a laser processing on the substrate, wherein the laser processing comprises laser drilling, laser cutting, laser grooving, laser trimming, laser trenching or any combination thereof.

In some embodiments, the fluid applying step 302 further comprises: a fluid membrane forming step 304, forming a fluid membrane on the substrate, wherein the fluid membrane is formed by of the fluid adhering on the substrate, and the laser applying step 303, applying the laser to the substrate under the fluid membrane so as to perform the laser processing on the substrate and generate a through hole. In some embodiments, the method for processing substrate by using laser 30 can be used for: generating the through hole or a blind hole on the substrate by the drilling; dividing the substrate into at least two substrate sections by the cutting; and performing the grooving, the trimming, and the trenching on the surface of substrate or one the edge of substrate.

In some embodiments, the fluid comprises water mist, compressed air, or a carbon-containing material fluid, and the carbon-containing material fluid comprises carbon nanotube (CNT) nanofluid, graphite nanoplatelet nanofluid, graphene nanoplatelet nanofluid, fullerene nanofluid, carbon nanoribbon nanofluid, carbon nanowire nanofluid, carbon nano fiber nanofluid or any combination thereof. Accordingly, the fluid membrane comprises water mist membrane, compressed air membrane, carbon-containing material fluid membrane, the substrate comprises silicon wafer, silicon carbide, gallium nitride, gallium arsenide, aluminum nitride, compound semiconductor, molding compound, or glass.

In some embodiments, the method for processing substrate by using laser 30 further comprises a parameter optimum value predicting step 305, predicting an optimum value of a parameter in the laser applying step by using an artificial neural network (ANN) model, wherein the parameter predicting step predicts an optimum parameter of the laser process under an air condition without applying the fluid, wherein the optimum parameter comprises depth of drilling, taper angle, aspect ratio, HAZ, or any combination thereof. The optimum parameter is predicted under the environment without applying the fluid so that the prediction, which is simplified, can be performed at a low cost; and the difference between the prediction performed under the environment without applying the fluid and the prediction performed under the environment with applying the fluid should be theoretically minimal. In other words, predicting the optimum parameter under the environment without applying the fluid is cost-competitive. The parameter optimum value predicting step 305 comprises performing the method for predicting optimum parameter using artificial neural network 10, it will not be further described more.

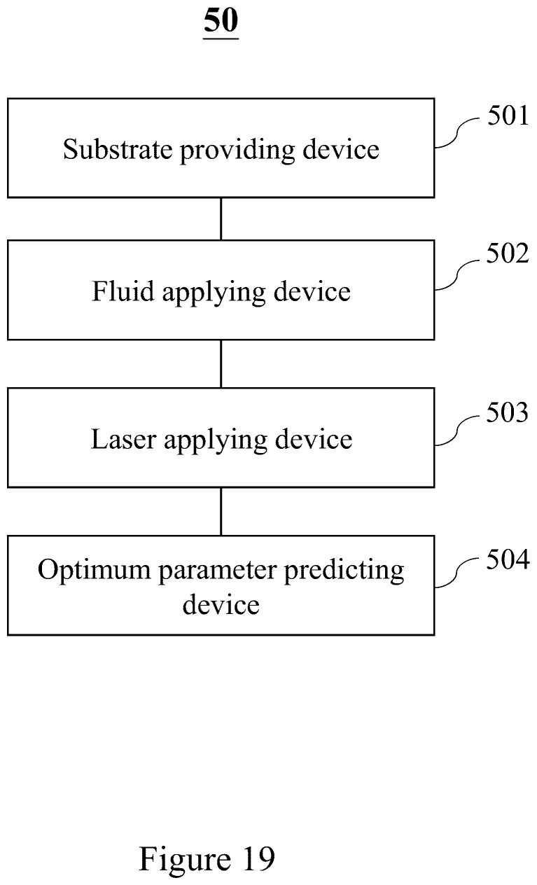

With reference to FIG. 19, the present invention provides a system for processing substrates by using laser 50, comprising: a substrate providing device 501, configured to provide the substrate; a fluid applying device 502, electronically connected to the substrate providing device 501, and configured to apply a fluid on the substrate; and a laser applying device 503, electronically connected to the fluid applying device 502, configured to apply a laser on the substrate covered by the fluid, so as to perform a laser process, wherein the laser process comprises: drilling, cutting, grooving trimming, trenching, or any combination thereof.)

In some embodiments, the system for processing substrates by using laser 50 provided by the present invention can be used for generating a through hole or a blind hole on the substrate by the drilling; dividing the substrate into at least two substrate sections by the cutting; and performing the grooving, the trimming, and the trenching on the surface of substrate or one the edge of substrate. In addition, the system for processing substrates by using laser 50 further comprises an optimum parameter predicting device 504, electronically connected to the laser applying device 503, configured to predicting an optimum value of a parameter of the laser by using an artificial neural network (ANN) model, wherein an optimum parameter of the laser process is predicted under an air condition without applying the fluid, wherein the optimum parameter comprises depth of drilling, taper angle, aspect ratio, HAZ, or any combination thereof. The optimum parameter is predicted under the environment without applying the fluid so that the prediction, which is simplified, can be performed at a low cost; in other words, predicting the optimum parameter under the environment without applying the fluid is cost-competitive. The optimum parameter predicting device 504 can use method introduced in the parameter optimum value predicting step 305, it will not be further described more.

In some embodiments, the fluid provided by the fluid applying device 502 comprises water mist, compressed air, or a carbon-containing material fluid, and the carbon-containing material fluid comprises carbon nanotube (CNT) nanofluid, graphite nanoplatelet nanofluid, graphene nanoplatelet nanofluid, fullerene nanofluid, carbon nanoribbon nanofluid, carbon nanowire nanofluid, carbon nano fiber nanofluid or any combination thereof. Accordingly, the fluid membrane comprises water mist membrane, compressed air membrane, carbon-containing material fluid membrane, the substrate comprises silicon wafer, silicon carbide, gallium nitride, gallium arsenide, aluminum nitride, compound semiconductor, molding compound, or glass.

In this invention, in order to perform an experiment for producing TSV by laser drilling, in the laser drilling, the parameter of laser (pulse energy and pulse number) and the environment in which the laser applies (DLM, ALM, WLM, and CLM) are changed. As the result, with regard to the environment, CLM group that uses CNT-nanofluid during the laser drilling contributes to the quality of TSV. Meanwhile, effects of all the environments on the parameter of TSV comprising diameter of the hole, thickness of the recast layer, thickness of heat affected zone, aspect ratio, and taper angle can be observing in the present invention. The following is a summary of the technical characteristics of the present invention:

As the pulse energy and the pulse number increase, the size of TSV increases.

The quality of TSV produced using the CLM process is better, and with regard to the TSV produced using the CLM process, the recast layer is 7 μm, the thickness of HAZ is 50 μm, and the taper angle is 1.05°.

Due to the CNT-nanofluid has higher conductivity, CLM process contributes to improve the removal rate of material (leading to large diameter of entrance and exit of TSV), and contributes to reduce the damage of TSV′ inner wall caused by fragments.

In a given range of value, compared to DLN and ALM, CLM and WLM process are relatively preferred.

In WLM group, hydrothermal reaction may be the main mechanism that generates no fragments on the surface during the process. In CLM group, reasonable mechanism that improves the thermal convection may comprises: reducing the thickness of thermal boundary layer, rearranging the nanoparticles, and increasing the shear-coupled thermal conductivity.

Compared to laser process assisted with submerged or static water, laser process assisted with spraying fluid as provided by the present invention can be used to eliminate the accumulation of air bubbles during the interaction between laser materials.

As a result of the present invention, the TSV may have higher aspect ratio, lesser recast layer, less taper angle, and less thickness of HAZ, the process for producing the TSV may have higher ablation rate. In the new CLM process, the present invention provides a method that can control the concentration and flow rate of CNT-nanofluid in the process carefully so as to obtained smoother surface of TSV in micro manufacture field.

In some explanatory embodiments of the present invention, a laser process is performed to produce a TSV (may refer to the “through substrate via” or “through silicon via”), a TGV (through glass via), a TMV (through mold via), a TCV (through compound via) and not limited to this. Accordingly, for the TSV, the substrate may refer to glass, third generation semiconductor, compound semiconductor, or molding compound; for the TCV, the substrate may refer to silicon carbide, gallium nitride, gallium arsenide, or aluminum nitride. The type of the laser process comprises drilling, cutting, grooving, trimming, or trenching, for example, the all types of the laser process can be assisted with spraying fluid as provided by the present invention.

In summary, the present invention uses the artificial neural network for simulating and predicting the optimum parameter under the atmosphere without applying the fluid, and performs laser drilling with the assistance of spraying fluid. After the validation, the method for producing the TSV using the nanosecond laser drilling, which is provided by the present invention, is proven to effectively and cost-efficiently produce the TSV, therefore, the new TSV producing method provided by the present invention can be used to solve the current problem of laser drilling.

The disclosure has been described above are just some preferred embodiments of the present invention, and should not be used for limiting the claims of the present invention; In other words, any modifications and similar arrangements based on the present invention, should be included and protected by the claim of the present invention.

What is claimed is:

1. A method for processing substrate by using laser, comprising:
a substrate providing step: providing a substrate;
a fluid applying step: applying a fluid on the substrate; and
a laser applying step: applying a laser through the fluid and performing a laser processing on the substrate so as to obtain a processed substrate, wherein the laser processing comprises laser drilling, laser cutting, laser grooving, laser trimming, laser trenching, or any combination thereof.

2. The method as claimed in claim 1, wherein the substrate comprises silicon, silicon carbide, gallium nitride, gallium arsenide, aluminum nitride, or any combination thereof.

3. The method as claimed in claim 1, wherein the fluid comprises fluid membrane.

4. The method as claimed in claim 3, wherein the fluid comprises gas, liquid, or a combination thereof.

5. The method as claimed in claim 4, wherein the gas comprises air or compressed air.

6. The method as claimed in claim 4, wherein the liquid contains nanomaterial, comprising: nanotube, nanoplatelet, nanoribbon, nanowire, nanofiber, or any combination thereof.

7. The method as claimed in claim 6, wherein the nanomaterial comprises carbon-based nanomaterial, comprising: carbon nanomaterial, graphite nanomaterial, graphene nanomaterial, fullerene nanomaterial, or any combination thereof.

8. The method as claimed in claim 6, wherein the volume fraction of the nanomaterial in the liquid ranges from 0.5-3.0 vol %.

9. The method as claimed in claim 1, further comprising:
a parameter optimum value predicting step: before the fluid applying step, predicting an optimum value of a parameter by using an artificial neural network (ANN) model, wherein the optimum value of the parameter corresponds to an optimum laser value of the laser, and the parameter relates to the processed substrate.

10. The method as claimed in claim 9, wherein the parameter optimum value predicting step comprises:
a model establishing step: establishing a value design model containing a laser value comprising a pulse energy value of the laser and a pulse number value of the laser;
a first simulating step: performing a first substrate processing simulation by using N of the laser values in the value design model, thereby obtaining a first simulating result, wherein the N is a positive integer;
a first experimenting step: performing a first substrate processing experiment by using a part of the N of the laser value in the value design model, thereby obtaining a first experimenting result;
a extracting step: extracting a first value of the parameter from the first simulating result and extracting a second value of the parameter from the first experimenting result;
a simulating result validating step: comparing the first value of the parameter with the second value of the parameter so as to validate the simulating result;
a model confirming step: confirming whether the value design model is reliable, if not, return to the simulating step for reassessing the value design model;
an artificial neural network training step: following the model confirming step if the value design model is reliable, calculating the N of laser values in the value design model by using an artificial intelligence software, so as to train the artificial neural network (ANN) model;
a processing map establishing step: establishing a processing map for the parameter by using the artificial neural network (ANN);
a processing map overlaying step: overlaying the processing map so as to establish a final processing map; and
a processing map filtering step: filtering the final processing map so as to recognize an ideal region on the final processing map, wherein the ideal region comprises the optimum laser value.

11. The method as claimed in claim 10, further comprising:
a second simulating step: performing a second substrate processing simulation by using the optimum laser value, so as to generate a second simulating result; and
a simulating result drawing step: analyzing and drawing the second simulating result.

12. The method as claimed in claim 10, further comprising:
a second experimenting step: performing a second substrate processing experiment by using the optimum laser value, so as to generate a second experimenting result; and
a SEM analyzing step: analyzing a substrate structure of the second experimenting result by using a scanning electron microscope (SEM).

13. A method for processing substrate by using laser, comprising:
a substrate providing step: providing a substrate;
a parameter optimum value predicting step: predicting an optimum value of a parameter of the substrate by using an artificial neural network (ANN) model, thereby obtaining an optimum laser value; and
a laser applying step: applying a laser and performing a laser processing on the substrate according to the optimum laser value; wherein the laser processing comprises laser drilling, laser cutting, laser grooving, laser trimming or laser trenching.

14. The method as claimed in claim 13, wherein the parameter optimum value predicting step comprises:
a model establishing step: establishing a value design model containing a laser value comprising a pulse energy value of the laser and a pulse number value of the laser;
a first simulating step: performing a first substrate processing simulation by using N of the laser value in the value design model, and thereby obtaining a first simulating result, wherein the N is positive integer;
a first experimenting step: performing a first substrate processing experiment by using a part of the N of the laser value in the value design model, thereby obtaining a first experimenting result;
an extracting step: extracting a first value of the parameter from the first simulating result and extracting a second value of the parameter from the first experimenting result;
a simulating result validating step: comparing the first value of the parameter with the second value of the parameter so as to validate the simulating result;
a model confirming step: confirming whether the value design model is available, if not, get back to the simulating step for reassessing the value design model;
an artificial neural network training step: following the model confirming step if the value design model is reliable, calculating the N of laser values in the value design model by using an artificial intelligence software, so as to train the artificial neural network (ANN) model;
a processing map establishing step: establishing a processing map for the parameter by using the artificial neural network (ANN);
a processing map overlaying step: overlaying the processing map so as to establish a final processing map; and
a processing map filtering step: filtering the final processing map so as to recognize an ideal region on the final processing map, wherein the ideal region comprises the optimum laser value.

15. The method as claimed in claim 13, further comprising:
a fluid applying step: applying a fluid on the substrate before the laser applying step, wherein at the laser applying step, the laser is applied for performing the laser processing on the substrate through the fluid.

16. The method as claimed in claim 15, wherein the fluid comprises a carbon material containing nanofluid comprising: carbon nanotube (CNT) nanofluid, graphite nanoplatelet nanofluid, graphene nanoplatelet nanofluid, fullerene nanofluid, carbon nanoribbon nanofluid, carbon nanowire nanofluid, carbon nano fiber nanofluid, or any combination thereof.

17. A system for processing substrate by using laser, comprising:
a substrate offering device for offering a substrate;
a fluid applying device, which is connected to the substrate offering device and is used for applying a fluid on the substrate; and
a laser applying device, which is connected to the fluid applying device and is used for applying a laser through the fluid and performing a laser processing comprising laser drilling, laser cutting, laser grooving, laser trimming, laser trenching, or any combination thereof.

18. The system as claimed in claim 16, wherein the substrate offering device comprises a laser work stage used for placing the substrate.

19. The system as claimed in claim 17, wherein the fluid applying device comprises a nozzle, which is arranged on the laser work stage and is used for spraying water mist, compressed air, or carbon material containing fluid on the substrate. 20 The system as claimed in claim 16, further comprising:
an optimum value predicting device, which is connected to the laser applying device, and is used for predicting an optimum value of a parameter by using an artificial neural network (ANN) model.
